(19) United States
(12) Patent Application Publication
(10) Pub. No.: US 2010/0263258 A1
(43) Pub. Date: Oct. 21, 2010

(54) Fishing lure

(76) Inventor: William Hinz, Falls City, NE (US)

Correspondence Address: THOMTE LAW OFFICE, L.L.C., 2120 S. 72ND STREET, SUITE 1111, OMAHA, NE, 68124, US

(21) Appl. No.: 12/386,242

(22) Filed: Apr. 15, 2009

(51) Int. Cl. A01K 85/10; A01K 85/00

(52) U.S. Cl. 43/42.13; 43/42.09

(57) ABSTRACT

A fishing lure device is provided which includes a frame having an eye at the forward end thereof with first and second rearwardly extending and diverging frame members extending therefrom. Spinner blades or buzz blades are rotatably mounted on the first frame member and a fish lure is attached to the rearward end of the second frame member by means of a quick-attach mechanism so that different fish lures may be selectively removably positioned on the rearward end of the second frame member.

### BACKGROUND OF THE INVENTION

1. Field of the Invention

This invention relates to a fishing lure and more particularly to a fishing lure wherein the lure portion thereof may be quickly and easily removed therefrom and replaced by another lure.

2. Description of the Related Art

FIG. 1 illustrates a prior art fishing lure device 10 which comprises a wire frame 12 including frame members 14 and 16 which extend rearwardly from an eye 18 in a diverging relationship. The eye 18 is adapted to have a fishing line secured thereto in conventional fashion. Spinner blades 20 are attached to frame member 14 in conventional fashion. Often, the lure device 10 will have buzz blades rotatably mounted on frame member 14 rather than the spinner blades 20. A weight 22 is affixed to the rearward end of frame member 16 and usually is shaped and colored to resemble a bait fish. Fish hook 24 extends rearwardly from weight 22 with strands or filaments 26 extending rearwardly from weight 22 to camouflage fish hook 24. Although the prior art fishing lure device 10 does satisfactorily perform, if the fisherman desires to use another lure with the same type of spinner blade arrangement as seen in FIG. 1, the fisherman must replace the entire fishing lure device 10 since the weight 22, hook 24 and filaments 26 are permanently attached to the frame member 16 of wire frame 12. Further, if the frame 12 becomes damaged so as to require the replacement thereof, the entire lure device must be replaced. If the fish hook 24 becomes damaged so as to require replacement thereof, the entire fishing lure device must be replaced.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A fishing lure device is disclosed comprising a wire frame means having a forward end and a rearward end with the frame means including an eye device at its forward end for receiving one end of a fishing line. The wire frame means includes first and second frame members extending from the eye device in a generally rearwardly and diverging manner. The first frame member has at least one blade rotatably mounted thereon which may be a spinner blade or a buzz blade. The second frame member has a quick-attach mechanism at its rearward end to enable a fishing lure to be selectively removably attached thereto.

It is a principal object of the invention to provide an improved fishing lure device.

A further object of the invention is to provide a fishing lure device wherein different lures may be attached thereto without replacing the entire lure device.

A further object of the invention is to provide a fishing lure device including a quick-attach mechanism to enable different lures to be mounted thereon.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of a prior art fishing lure;

FIG. 2 is a perspective view of the fishing lure of this invention;

FIG. 3 is an exploded perspective view of a modified form of this invention;

FIG. 4 is a view similar to FIG. 3 except that the lure has been attached to the wire frame;

FIG. 5 is a view similar to FIG. 4 except that the wire frame has a pair of buzz blades secured thereto;

FIG. 6 is a view similar to FIG. 2 with FIGS. 5 and 6 illustrating the manner in which different lures may be attached to the wire frames; and

FIG. 7 is a perspective view illustrating the manner in which a lure may be attached to two different blade arrangements.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

As stated above, FIG. 1 illustrates a prior art fishing lure device 10 which comprises a wire frame 12 including frame members 14 and 16 which extend rearwardly from an eye 18 in a diverging relationship. The eye 18 is adapted to have a fishing line 19 secured thereto in conventional fashion. Spinner blades 20 are attached to frame member 14 in conventional fashion. Often, the lure device 10 will have one or more buzz blades 21 rotatably mounted on frame member 14 rather than the spinner blades 20. A weight 22 is affixed to the rearward end of frame member 16 and usually is shaped and colored to resemble a bait fish. Fish hook 24 extends rearwardly from weight 22. Usually, strands or filaments 26 extend rearwardly from weight 22 to hide, shield or camouflage the fish hook 24.

If the fisherman desires to use another lure with the same type of spinner blade arrangement as seen in FIG. 1, the fisherman must replace the entire lure device 10 since the weight 22, hook 24 and filaments 26 are permanently attached to the wire frame 12. Further, if the frame 12 becomes damaged so as to require the replacement thereof, the entire fishing lure device 10 must be replaced. If the fish hook 24 becomes damaged so as to require replacement thereof, the entire fishing lure device 10 must be replaced.

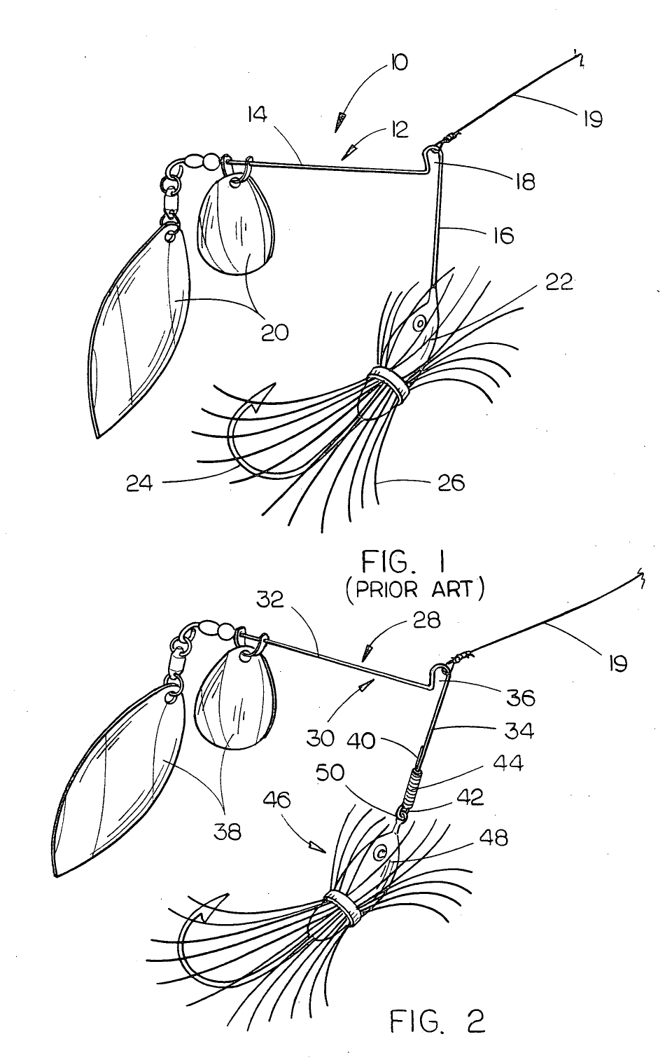

One form of the improved fishing lure device of this invention is shown in FIG. 2 and designated by the reference numeral 28. Device 28 includes a wire frame 30 including frame members 32 and 34 extending from eye 36. Spinner blades 38 are attached to frame member 32 in conventional fashion. Frame member 34 has an end portion 40 which extends forwardly from an eye or loop portion 42. A tubular member 44 is loosely slidably mounted on frame member 34 and may be slipped rearwardly over end portion 40, when end portion 40 has been pressed, pushed or deflected towards frame member 34 so that the eye 42 will be closed.

The numeral 46 refers to a lure including a weight 48 having an eye 50 which may be selectively removably received by the loop portion 42. Obviously, the eye 50 is attached to the loop portion 42 prior to the tubular member 44 being moved rearwardly on frame member 34 to close the loop portion 42.

In the lure device 28, if the fisherman desires to replace the lure 46 with a different lure, the tubular member 44 is slipped forwardly on frame member 34 to release the end portion 40. The lure 46 is then removed from the loop portion 42 and a different lure is mounted on the loop portion 42 with the tubular member 44 then being moved rearwardly over end portion 40 to “lock” the different lure onto the device.

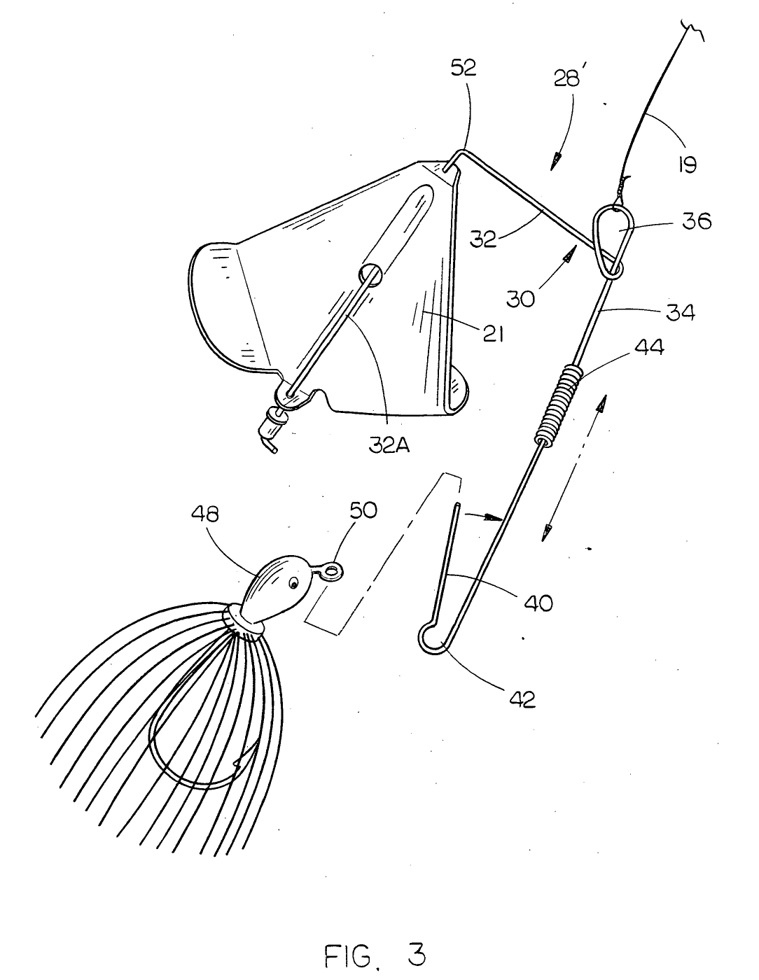

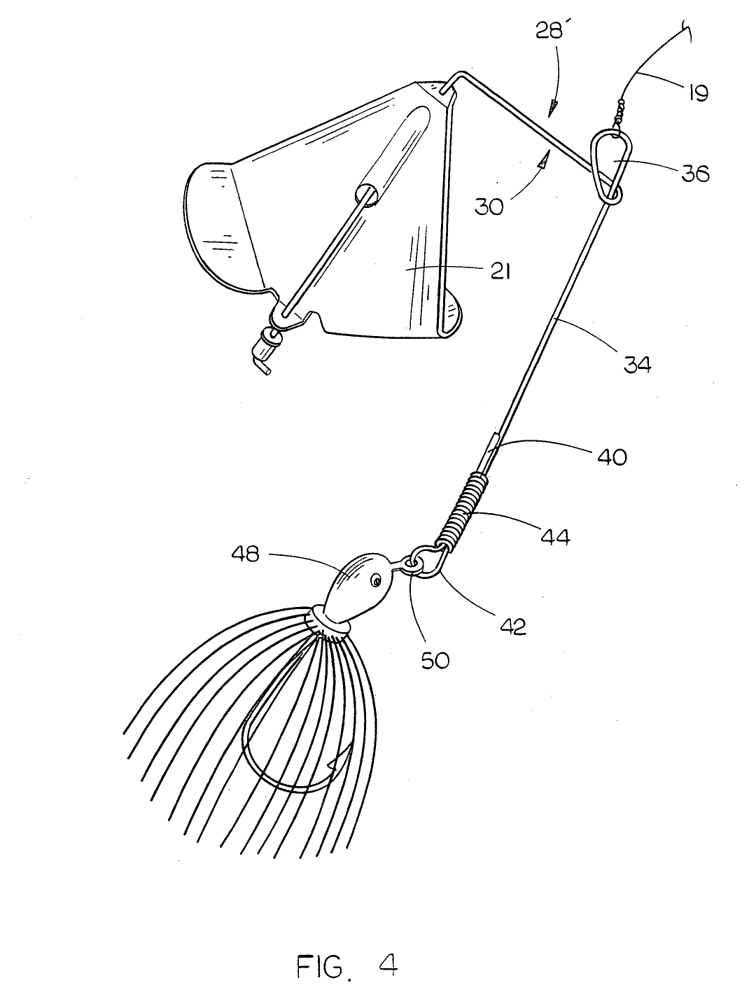

In FIG. 3, a modified form of the fishing lure device is illustrated and referred to by the reference numeral 28′. The only difference between that shown in FIG. 2 and in FIG. 3 is that the wire frame 30′ is bent at 52 and that one or more buzz blades 21 are rotatably mounted on the rearwardly extending portion 32A of frame member 32. The eye 18 in FIG. 3 is also somewhat different than the eye 36 in FIG. 2.

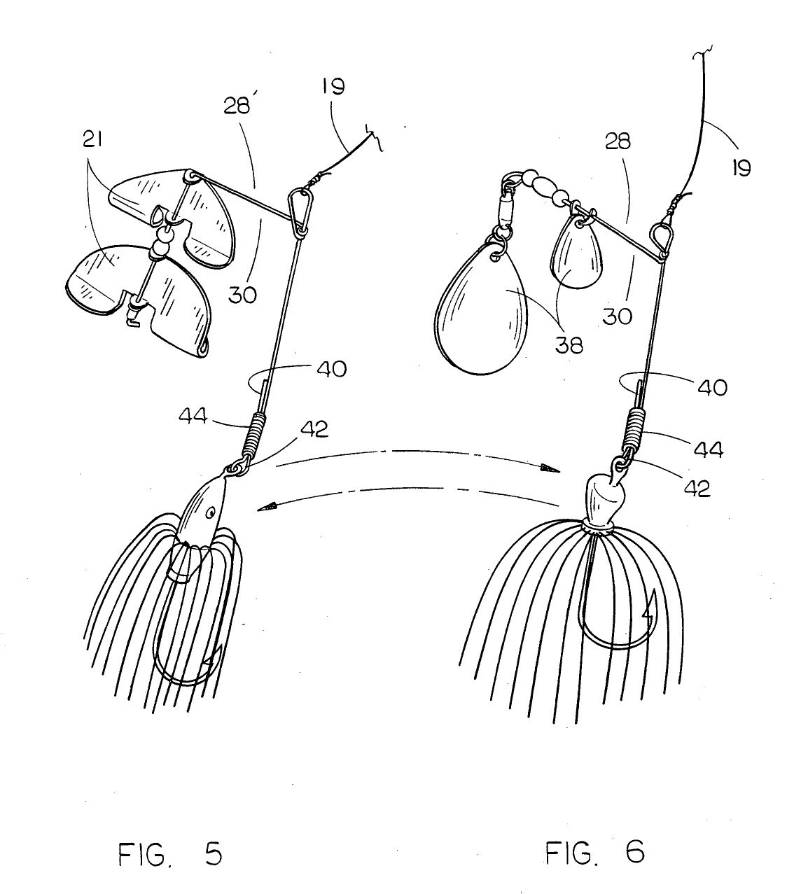

As seen in FIGS. 5 and 6, the device 28 and the device 28′ may have different lures quickly and easily attached thereto without replacing the entire device. It can therefore be seen that the device of this invention accomplishes at least all of its stated objectives.

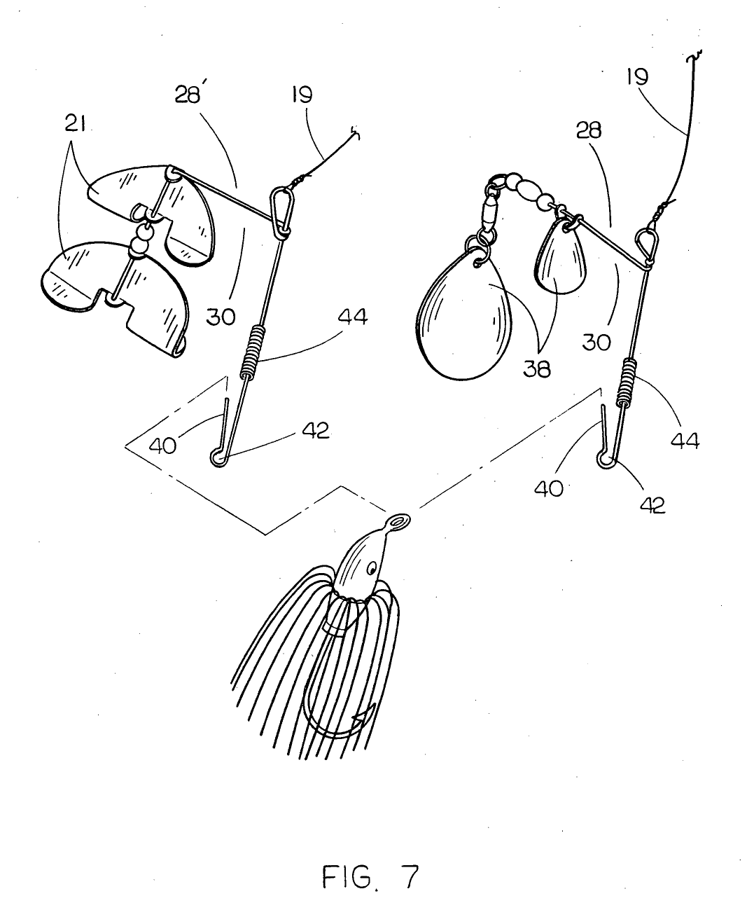

As seen in FIG. 7, the same lure may be attached to either the wire frame 30 or the wire frame 30′ to provide two different lures with one lure being used with the buzz blades 21 of wire frame 28′ so that the lure is a surface lure or with the wire frame 28 with the spinner blades 38 so that the lure becomes a sub-surface lure. Further, the buzz blades 21 and spinner blades 38 may be used with other lures at the fisherman's discretion.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A fishing lure device, comprising:
a frame means having a forward end and a rearward end;
said frame means including an eye device at its forward end for receiving one end of a fishing line;
said frame means including first and second frame members extending from said eye device in a generally rearwardly and diverging manner;
said first frame member having at least one blade rotatably mounted thereon;
said second frame member having a quick-attach mechanism at its rearward end to enable a fishing lure to be selectively removably attached thereto.

2. The fishing lure device of claim 1 wherein a spinner blade is rotatably mounted on said first frame member.

3. The fishing lure device of claim 1 wherein a plurality of spinner blades are rotatably mounted on said first frame member.

4. The fishing lure device of claim 1 wherein a buzz blade is rotatably mounted on said first frame member.

5. The fishing lure device of claim 1 wherein a plurality of buzz blades are rotatably mounted on said first frame member.

6. The fishing lure device of claim 1 wherein the rearward end of said second frame member has a U-shaped portion formed therein with a forwardly depending end portion and wherein a tubular member is slidably mounted on said second frame and which may be slidably moved rearwardly on said second frame member to embrace said forwardly depending end portion to provide a means for selectively removably attaching a fishing lure to said U-shaped portion.

7. The fishing lure of claim 6 wherein said tubular member comprises an elongated coil spring.
